(19) United States
(12) Patent Application Publication
(10) Pub. No.: US 2025/0285254 A1
(43) Pub. Date: Sep. 11, 2025

(54) VISION-BASED SYSTEM AND METHOD

(71) Applicant: Toyota Material Handling, Inc., Columbus, IN (US)

(72) Inventors: Joshua G. Linnemann, Columbus, IN (US); Mustafa Parlaktuna, Indianapolis, IN (US)

(21) Appl. No.: 19/071,889

(22) Filed: Mar. 6, 2025

Related U.S. Application Data
(60) Provisional application No. 63/562,158, filed on Mar. 6, 2024.

(51) Int. Cl. G06T 7/00; G06V 10/70; G06V 20/52; G06V 40/20

(52) U.S. Cl. CPC G06T 7/0002; G06V 10/70; G06V 20/52; G06V 40/20; G06T 2207/20081; G06T 2207/30252; G06V 2201/07

(57) ABSTRACT

A vison-based system and method for assessing a condition of a component of a material handling vehicle and monitoring the use of personal protective equipment (PPE) and vehicle charging by operators are provided. The vison-based system includes one or more cameras of a perception system. The perception system can be configured to receive or otherwise retrieve input data from the one or more cameras and process the input data using a machine learning system. The system can identify the condition of the component(s) of the material handling vehicle, categorize the identified condition based on the output of the machine learning system, classify a severity of the condition, and generate a notification.

### CROSS-REFERENCE TO RELATED APPLICATIONS

This application claims priority under 35 U.S.C. § 119 to U.S. Provisional Patent Application No. 63/562,158, filed Mar. 6, 2024, the entire contents of which are incorporated herein by reference.

### BRIEF SUMMARY

This disclosure generally relates to material handling vehicles. More specifically, this disclosure relates to material handling vehicles equipped with a vision-based system.

### BACKGROUND

Material handling vehicles, such as forklifts, can include components that experience wear through normal use, which may affect the performance of the vehicle and/or the comfort of the operator of the vehicle if not monitored and maintained. Conventional material handling vehicle systems lack the ability to visually detect and assess (without manual inspection by an operator) the condition of various components of the vehicle before the components are damaged or deteriorated to a level that negatively impacts the performance and/or results in expensive repairs.

In addition, regulatory authorities, such as the Occupational Safety and Health Administration (OSHA) direct the use of personal protective equipment (PPE), e.g., face shields, aprons, and rubber gloves, for operators handling hazardous materials, for example, operators handling acids or batteries. Some work environments call for the use of high-visibility vests, safety glasses, hard hats, etc. Conventional material handling systems and methods lack the ability to automatically detect and enforce compliant use of PPE by operators unless a supervisor is present.

### SUMMARY

In an aspect of the present disclosure, a vison-based system for assessing a condition of a component of a material handling vehicle is provided. The system includes an advanced perception system comprising one or more cameras, a memory unit, and a processor. The perception system is configured to receive input data from the one or more cameras and process the input data using a machine learning system. The machine learning system is trained to identify a condition of a component of the material handling vehicle and categorize the identified condition. The perception system is further configured to generate a notification of the condition.

In some aspects, the identified condition of the component may be categorized as “Good” or “Poor”. The identified condition may also be classified according to a scale associated with the severity of the condition. In some forms, the component may be a seat of the material handling vehicle, a tire of the material handling vehicle, an overhead guard (OHG) of the material handling vehicle, a counterweight (CW) of the material handling vehicle, or a combination thereof.

In another aspect, a vison-based system for monitoring an operator's use of personal protective equipment (PPE) is provided. The system includes a camera of an advanced perception system. The perception system is configured to receive input data from the camera and process the input data using a machine learning system. The machine learning system is trained to identify whether a target PPE item is present and categorize the target PPE item as being present or absent. The perception system is further configured to generate a notification related to the target PPE item being present or absent based on an output of the machine learning system.

In some aspects, the target PPE may include a face shield, an apron, gloves, safety glasses, a vest, a hard hat, or a combination thereof. In some forms, the perception system is further configured to detect a target object and a target action. In some embodiments, the target object can include a battery, a forklift, a warehouse item, a walkway, or a combination thereof. The target action can include watering the battery, operating the forklift, carrying a load, approaching a walkway, or a combination thereof. In some aspects, the machine learning system is further configured to detect the target action in the input data and recognize the target action using one or more image processing techniques. The system is further configured to determine the target PPE associated with the target action and identify the presence or absence of each aspect of the target PPE based on the one or more image processing techniques. The system is also configured to generate a notification including the target action, any target objects, the target PPE associated with the target action, and an output including a description or other indication of the aspects of the target PPE that are present and/or absent based on the output of the machine learning system.

In another aspect, a method for operating a vision-based system for monitoring the use of PPE by operators handling acids or batteries is provided. The method includes receiving input data from one or more cameras of the perception system and processing the input data using a machine learning system. The machine learning system is trained to identify whether a target PPE item is present or absent and categorize the target PPE item as being present or absent. The method also includes the step of generating a notification based on whether the target PPE item is present or absent. In some forms, the machine learning system is trained to identify and classify other items related to the operator, including a battery, an action of watering the battery, or similar. The system is further configured to generate a notification based on whether the target PPE item is present or absent from the input data.

In some aspects, the target PPE may be a face shield, an apron, gloves, gloves, safety glasses, a vest, a hard hat, or a combination thereof. In some forms, the method is further configured to determine whether a target object is present in the input data. The target object is categorized as being correct or not correct based on an output. An updated notification may be generated to indicate whether the target object is correct or not. In some forms, the input data from one or more cameras comprises image data. In some aspects, the one or more target objects are associated with one or more zones. In some embodiments, the machine learning system further identifies one or more target conditions and one or more target locations. In some forms, the one or more target conditions and the one or more target locations are associated with the one or more zones. In some aspects, the one or more target conditions and the one or more target locations are associated with charging the material handling vehicle. In some embodiments, the notification includes one or more images captured by the one or more cameras.

### BRIEF DESCRIPTION OF DRAWINGS

FIG. 1 is a side elevational view of a material handling vehicle according to an embodiment;

FIG. 2 is a block diagram for a vision-based method for detecting a condition of a component of a material handling vehicle according to an embodiment;

FIG. 3 is a block diagram showing a vision-based method for detecting the use of PPE according to an embodiment; and

FIG. 4 is a black diagram showing a vision-based method for analyzing and detecting vehicle charging according to an embodiment.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

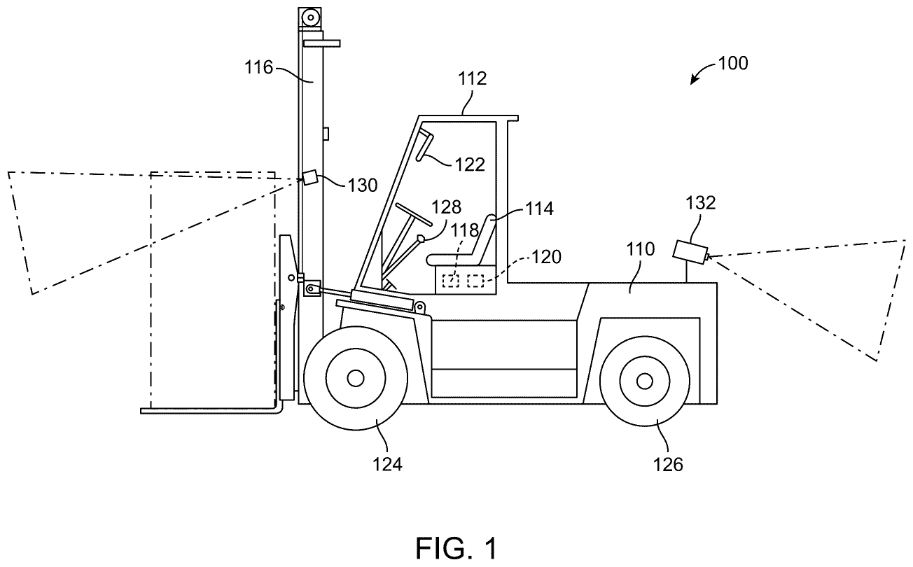

FIG. 1 illustrates a material handling vehicle 100 according to one embodiment. The material handling vehicle 100 can comprise a body 110, an operator cab 112, a driver's seat 114, a mast 116, a processor 118, one or more feedback devices 120, a display module 122, one or more front tires 124, one or more rear tires 126, and a control module 128. In some embodiments, the material handling vehicle 100 is operated by a driver who sits in the driver's seat 114 but in some other forms, the material handling vehicle can operate autonomously or via remote control. In the manual driver operation form, the driver can use the control module 128 to control the material handling vehicle 100, and the control module 128 can be provided in the form of a control lever. For example, the control module 128 may be used to shift the material handling vehicle 100 into forward or backward motions. There may be other control levers or instruments not pictured that the driver may use to direct the material handling vehicle 100 in different ways based on the task at hand (e.g., mast adjustment, tilt, auxiliary controls, etc.).

The material handling vehicle 100 includes a vision system that comprises the processor 118, one or more front-facing sensors 130, and one or more rear-facing sensors 132. The processor 118, the front-facing sensor 130, the rear-facing sensor 132, and the feedback device 120 are communicatively coupled to one another and can exchange information via a wired or wireless configuration. In some forms, the vision system includes its own processor, and the vision system and the feedback devices 120 are modular with respect to the material handling vehicle 100. Accordingly, the vision system and the feedback device 120 can be removably coupled to the material handling vehicle 100 and operatively coupled with the processor 118 of the material handling vehicle 100. In at least this way, the vision system and the feedback device 120 can be retrofitted onto a number of different types of material handling vehicles. In some embodiments, the vision system can include one or more aspects of the vision location tracking task and/or perception system described in U.S. patent application Ser. No. 18/352,839, entitled “ADVANCED MATERIAL HANDLING VEHICLE, filed Jul. 14, 2023, incorporated by reference in its entirety herein.

Although FIG. 1 shows the material handling vehicle 100 as a counterbalance-type forklift truck, this is not to be considered limiting. The material handling vehicle 100 may be provided in the form of any material handling vehicle or other vehicle used to transport materials. For example, the material handling vehicle 100 may be provided in the form of a reach truck, a stacker, a pallet truck, or an order picker, for example.

The feedback device 120 can be configured to alert the driver by auditory, visual, and/or tactile means provided in the form of sirens, horns, announcements, lights, strobes, images, vibrations, deacceleration, and/or pulsations. The feedback device 120 can, in some instances, generate data or an alert to be transmitted to the display module 122. The feedback device 120 can be provided in the form of one or more devices, including but not limited to a sensor, a sensor array, a switch, a speaker, one or more light(s), or a combination thereof, for example.

The front-facing sensor 130 and the rear-facing sensor 132 can be provided in the form of one or more cameras, laser scanners, accelerometers, gyro sensors, proximity sensors, radars, lidars, optical sensors (such as infrared sensors), acoustic sensors, barometers, thermometers, or other suitable sensors or any combination thereof. The front-facing sensor 130 is positioned to sense the environment in front of the material handling vehicle 100 and can be attached to the mast 116 or another portion of the front end of the material handling vehicle 100. The rear-facing sensor 132 is positioned to sense the environment behind the material handling vehicle 100 and can be positioned on or adjacent to the rear end of the body 110, for example. In some embodiments, the front-facing sensor 130 and/or the rear-facing sensor 132 may be configured to sensor and/or monitor an environment proximate to the material handling vehicle 100 (e.g., along the sides, on top, surrounding, etc.). In some aspects, the system may include additional sensors operatively coupled to the material handling vehicle 100 (e.g., additional onboard sensors, remote sensors, etc.).

The front-facing sensor 130 and the rear-facing sensor 132 can sense various parameters of the environment surrounding the material handling vehicle 100, such as visual, auditory, or other environmental features. One or more of the front-facing sensor 130 and the rear-facing sensor 132 can also be configured to generate sensor data and can communicate the corresponding sensor data with the processor 118 of the material handling vehicle 100. For example, the front-facing sensor 130 and the rear-facing sensor 132 can capture still or continuous images and provide the corresponding input data to the processor 118 for analysis. The processor 118 can send control signals to activate the feedback device 120 based on the analysis performed on the sensor data from the front-facing sensor 130 and the rear-facing sensor 132. In response to activation by the processor 118, the feedback device 120 can provide one or more notifications in the form of auditory, visual, or tactile sensory outputs. The notifications can be provided in the form of various alarms that alert the operator of the material handling vehicle 100 to the conditions of the surrounding environment. The feedback device 120 may positioned in a number of locations, such as within or under the seat 114, the operator cab 112, or anywhere else on the body 110 of the material handling vehicle 100, to facilitate notifying the operator or surrounding persons.

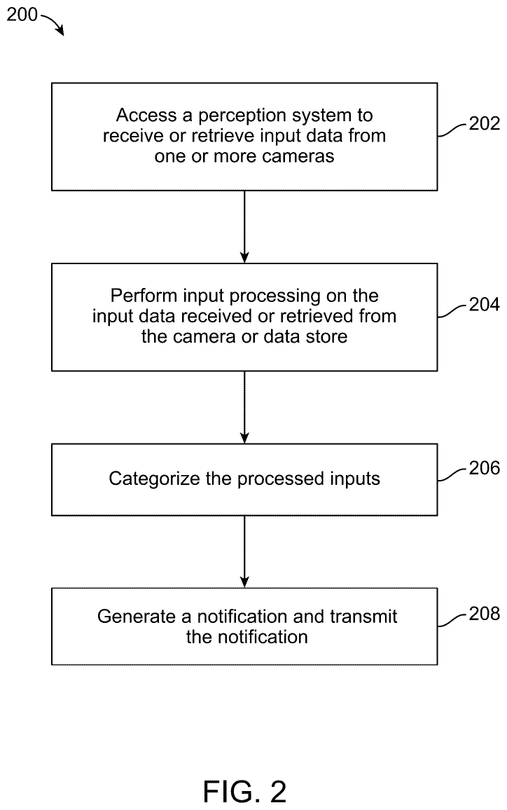

FIG. 2 illustrates a vision-based method 200 for detecting damage, defects, and/or wear associated with one or more components of a material handling vehicle, e.g., the material handling vehicle 100 of FIG. 1, for example. The vision-based method 200 may include accessing a perception system to receive or otherwise retrieve one or more images, processing the images, categorizing an identified condition, and generating a notification based on the identified condition and categorization.

At step 202, the vision-based system of a material handling vehicle 100 can access a perception system to receive or otherwise retrieve input data from one or more cameras of the perception system. The input data may be stored in a data store, cloud server, memory unit, or a combination thereof. In some embodiments, the input data may include image data. In some embodiments, the camera(s) can be provided in the form of an image sensor or similar data capture device. Examples of the camera may include the front-facing sensor 130 and the rear-facing sensor 132 of FIG. 1, for example. In some forms, the camera may be mounted on the material handling vehicle 100 to capture images of various portions of the material handling vehicle 100 (e.g., to provide a view of the interior of the cab 112). In some examples, the camera can be mounted in an environment surrounding the material handling vehicle 100 (e.g., in a warehouse, at a loading dock, around a job site, etc.) in order to provide a view of the exterior of the material handling vehicle 100. In one non-limiting example, the camera may be provided in a room or space in which the material handling vehicle 100 is located for visual inspection. In some forms, the perception system may be provided in the form of an integrated submodule of the processor 118 of FIG. 1. It will be understood that the perception system may be installed on the material handling vehicle 100 or may be provided external to the material handling vehicle 100.

At step 204, the perception system may be configured to perform image processing (or other forms of data processing) on the input data received or retrieved from the camera or data store (not shown). As a non-limiting example, the input data can include image data. As another non-limiting example, the system can process a first image frame including a tire. The system can use one or more advanced processing techniques to identify the tire and assess a condition of the tire. As another non-limiting example, the system can process a second image frame including a seat, (e.g., the driver's seat 114). The system can use one or more advanced processing techniques to identify the seat and assess a condition of the seat (e.g., exterior damage). In some embodiments, the system may use the one or more advanced processing techniques to identify signs of operator fatigue (e.g., facial fatigue, posture, drifting lanes, etc.). In one or more embodiments, the system may use the one or more advanced processing techniques to identify headlights associated with the material handling vehicle 100 and a direction which the lights are pointing. In some aspects, the system may identify the headlights and assess a condition of the headlights (e.g., brightness, state of health, lifespan remaining, etc.). In some embodiments, the system may use one or more artificial intelligence models to perform the identification and/or assessment processes.

The system may be adapted to generate, train, and execute one or more trained learning models, nodes, neural networks, gradient boosting algorithms, mutual information classifiers, random forest classifications, and other machine learning and artificial intelligence related algorithms or models to process the parameters, features, and other data elements. In some embodiments, the one or more trained learning models can include deep learning, machine learning, neural networks, computer vision, and similar advanced artificial intelligence-based technologies. When used throughout the present disclosure, one skilled in the art will understand that processes for iteratively training the “trained learning model” can include machine learning processes and other advanced artificial intelligence processes. For example, the vision-based system and method can perform data processing, perform image analysis, generate tasks or action items, provide customized recommendations according to user settings and preferences, generate interfaces, generate reports, generate files, generate notifications, and similar processes. In some embodiments, the system may use additional inputs and/or feedback loops to an iterative training process for enhanced image processing and identification processes based on various parameters, movements, and adjustable metric values.

At step 206, the perception system categorizes the processed inputs. For example, a condition of various components of the material handling vehicle 100 may be categorized as being “Good” or “Poor”. In some forms, the categories can be provided in the form of other metrics or scales (e.g., “Very Good,” “Very Poor,” “Excellent,” “Average,” “Maintenance,” “Repair,” “Replace,” “Calibrate,” etc.). In some aspects, the system can use a reference chart or other matching logic within the software component(s) of the system to determine and assign a category to a condition for each component identified at step 204. In some non-limiting embodiments, the system may monitor other components associated with the material handling vehicle 100 (e.g., an overhead guard (OHG), or a counterweight (CW), tines, accessories, etc.). The system can allow new components to be added for monitoring, new assessment categories, new parameters for evaluating the condition of a component, or any combination thereof. In one example, a trained learning model can generate a chart with the categorizations based on an output of the trained learning model. The system may also classify various levels of wear or damage identified, including on a scale ranking the severity of the wear or damage, provide a recommended timeline for repair or service, or a combination thereof. For example, the system can automatically identify the tire in the first image frame, assess the tire, and determine that the tire is in “Poor” condition based on extracted data points from the first image frame compared to parameters used to train a trained learning model. The system can also rank the condition on a scale, based on a comparison of the extracted data points to other data points. In a non-limiting example, the system can determine the tire is in “Poor” condition and due to the severity of the condition, assign a classification of “Replace Immediately”. However, embodiments are not limited to the above examples.

At step 208, the system can generate a notification and transmit the notification using the perception system, a notification module of the processor 118, or some other communication module (not shown). The notification may be transmitted, for example, to the driver of the material handling vehicle 100, to a centralized location, to a monitoring station, a computing device, a mobile device, a cloud server, or a similar computing system. The notification may include a flag message and/or metadata for a component with identified damage or wear. For example, a component categorized as “Poor” at step 206 can trigger a notification at step 208. The notification can include an image of a component with identified damage or wear (e.g., providing the first and second image frames respectively). For example, the notification can include the image of the fork tine component with an identified fork thickness and damage (e.g., through multiple images and virtual measurements, respectively). The notification, in some embodiments, can include the image of an overhead guard component with identified damage (e.g., overhead guard bent or broken). The notification can also include a description, error code, or other information related to the component identification, assessment, categorization, and classification. In some aspects, the notification can include the description of one or more lights burned out with associated instructions for repair or replacement. In some forms, a notification can include information identifying a categorization for all monitored components. The notification can be provided in the form of a chart, a report, GUI, interactive display, or similar output.

In addition to monitoring, identifying, and classifying the condition of one or more components of a material handling vehicle 100, the vision-based systems and methods can monitor, identify, and classify human activity. For example, the system can be used to monitor operators located in areas that may be considered dangerous or hazardous. In one non-limiting example, the vision-based system can be installed in a designated battery maintenance area or battery charger room to monitor activities related to handling battery acid. OSHA sets forth certain rules for PPE that shall be used when handling certain hazardous materials. For example, OSHA Standard 1926.441(a)(5) indicates that face shields, aprons, and rubber gloves shall be worn by operators handling acids or batteries. A vision-based system in accordance with the present disclosure may be designed to use computer vision or other trained learning models to monitor the operator(s) in a room (or space) to confirm the operators' compliance with PPE rules.

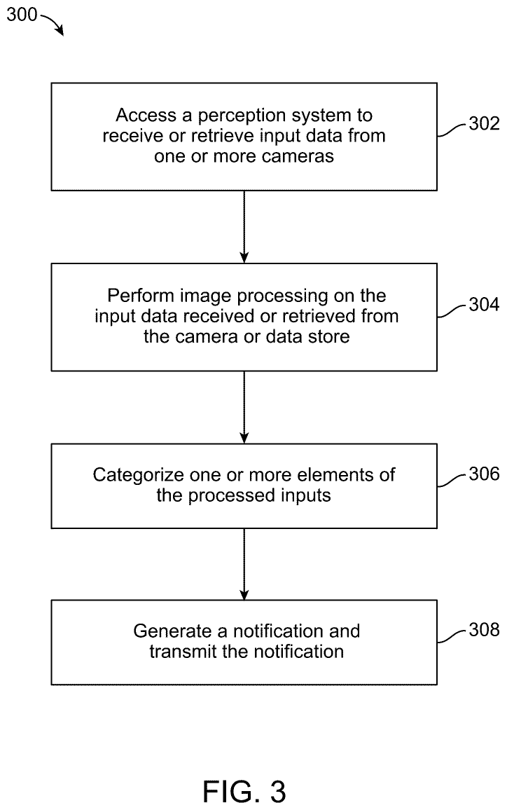

FIG. 3 illustrates a vision-based method 300 for detecting compliant PPE usage. For example, a perception system may process input data to identify and confirm an operator is equipped with the appropriate PPE for the designated task the operator is performing. As an example, if the perception system determines an operator is not using one or more pieces of designated PPE for the task being performed, the perception system can generate a notification. In some aspects, the notification may include an alert regarding improper PPE, and corrective action, including the type of PPE specified for the test, based on the PPE identified compared to the PPE designated for the task, using one or more trained models.

At step 302, the vision-based system of the material handling vehicle 100 can access a perception system to receive or otherwise retrieve input data from one or more cameras of the perception system. The input data may be stored in a data store, cloud server, memory unit, or a combination thereof. In some embodiments, the camera(s) can be provided in the form of an image sensor or similar data capture device. Examples of the camera may include the front-facing sensor 130 and the rear-facing sensor 132 of the material handling vehicle 100 of FIG. 1, for example. In some forms, the camera may be provided at various locations in the room or area being monitored. In one instance, the camera and/or other aspects of the perception system may be included in the processor 118 of FIG. 1, on a terminal device, on a mobile device, or a combination thereof. It will be understood that the examples provided are non-limiting.

At step 304, the perception system may be configured to perform image processing (or other types of data processing) on the input data received from the camera or data store. In an example but limited to, an image of an operator may be processed and one or more elements of the image identified by the perception system. The perception system can extract the image data from the image, recognize one or more items, objects, and/or features in the image, and identify the items, the objects, and/or the features to confirm the presence or absence of PPE based on the identified task being performed. In some embodiments, the perception system can identify damage to PPE or other protective gear. In some embodiments, the system can process information related to the location the image was taken (e.g., from metadata, GPS, geotag, geofence information, etc.) to identify the task being performed and/or the appropriate PPE for operators in that area. The computer vision and/or image processing techniques used at step 304 can include boundary boxes, template matching, image segmentation, blob analysis, masking, Gaussian blur, filtering, image enhancement, rotation, scale, color correction, crop, deep learning analysis, other forms of image analysis and processing, or any combination thereof.

In one non-limiting example, the system processes the image and identifies the operator is performing an action of watering a battery. The system determines the designated PPE for watering a battery (based on training data, input data, the data store, lookup tables, or other information) and identifies whether the one or more designated PPE pieces appear in the input data. For example, the operator watering the battery is expected to be wearing a face shield, an apron, and gloves. The system can also be configured to detect and identify a target object (e.g., a battery), detect and identify a target condition (e.g., no damage), and detect and identify a target action (e.g., watering the battery). In some embodiments, the system uses a trained learning model to determine the designated PPE for a target action and/or identify one or more of the designated PPE, target object, and/or target action related to the image processing and analysis. In some embodiments, the system may evaluate the target action based on the input data from one or more frames over a specified time period. In some forms, the designated PPE for specific tasks can be provided via user input, a data store input, or similar.

At step 306, the perception system can be configured to categorize one or more elements of the processed inputs. For example, each target PPE item may be categorized as being “Present” or “Absent”. For example, the system, may generate a chart comprising a list of all the recognized PPE items, target objects, and target actions identified in the image(s) by the vision-based system. The system recognizes, identifies, and categorizes each of the face shield, the apron, the gloves, the battery, and the action of watering the battery as being “Present” in the processed image. In one instance, the system may allow additional items to be added for monitoring. For example, the chart may include pre-populated categorizations based on training data. The system may also identify and categorize PPE for multiple operators. The system may also determine and/or classify whether an operator is using the PPE properly, (e.g., gloves on hands and not in a pocket, safety glasses worn over the eyes and not on the top of the head, etc.).

At step 308, the system can generate a notification to be transmitted. In some embodiments, the perception system can generate and/or transmit the notification. In some forms, the notification may be generated and/or transmitted using a notification module (not shown) of the processor 118, other communication module(s) of the material handling vehicle 100, or a remote processing device (e.g., telematics system, cloud server, etc.). The notification may be transmitted to the operator (via the onboard display device 122, a user mobile/computing device, or similar), broadcast to a room where the camera and/or perception system is located, transmitted to one or more users subscribed to the notification type, to a centralized location, to a cloud server, to a monitoring station, to generate a report, or similar. The notification may be provided in the form of an audible alarm, a text message, a telemetry communication from the vision-based system to a centralized database, a warning light, a display message, a vibration, a voice announcement, or a combination thereof. In one instance, the notification can include an image (e.g., an image of an operator who has been identified by the perception system as not using one or more pieces of designated PPE and/or a description of the designated PPE absent and/or present). In some embodiments, the system may automatically generate one or more annotated images including the image captured of the non-compliant operator compared to a compliant PPE configuration for the identified target action. The image and/or notification may be used, for instance, to identify the operator associated with an image, monitor PPE compliance violations, and generate a report or other output including a list of operators who may benefit from additional PPE training based on the identified and/or monitored behaviors.

In some forms, the output of the image processing at steps 204 and 304 can include an estimated accuracy or other details related to the assessment, identification, categorization, and classification of the input data, to help facilitate a supplemental review. If there is a high probability that a face shield, an apron, and/or gloves are not identified by the trained learning model, a notification may be generated and transmitted by the perception system (or other aspects of the vision-based system).

In some embodiments, the vision-based system and method can be used to determine if an operator is appropriately wearing PPE while operating the material handling vehicle 100 of FIG. 1. In some forms, the vision-based system can be configured to monitor a cab 112 of a material handling vehicle 100, receive inputs from the processor 118 to make a determination and process the input data. In some examples, the system can be used to determine if an operator has the seatbelt properly fastened and/or if the operator is not using a cell phone while the material handling vehicle is engaged and/or powered on. It will be understood that the examples described above are non-limiting.

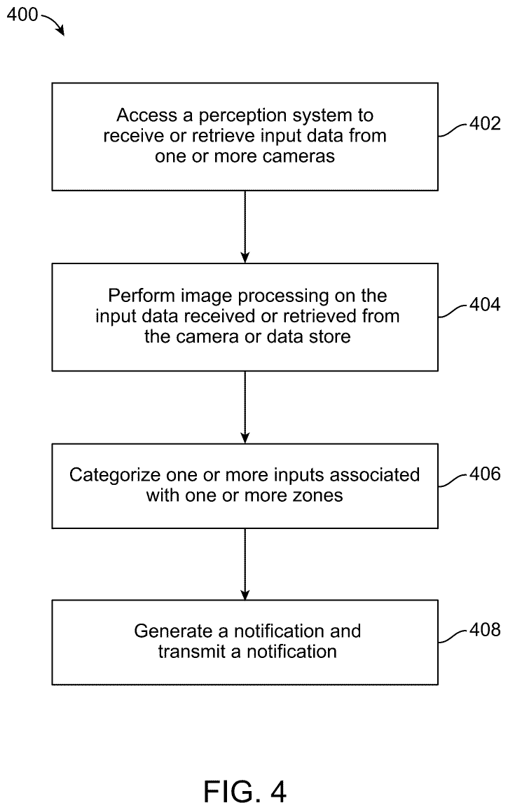

FIG. 4 illustrates a vision-based method 400 for detecting conditions associated with different areas or zones. For example, a perception system may process input data to identify and determine a charging cable is properly connected to the material handling vehicle 100. As an example, if the perception system detects that the material handling vehicle is parked at a charging station, but the charging cable is not connected to the material handling vehicle 100, the perception system can generate a notification notifying an operator and/or telematics system (or other device) that the material handling vehicle 100 is not properly connected.

At step 402, the vision-based system of the material handling vehicle 100 can access a perception system to receive or otherwise retrieve input data from one or more cameras of the perception system. The input data may be stored in a data store, cloud server, memory, unit or a combination thereof. In some embodiments, the input data may include image data. In some embodiments, the camera(s) can be provided in the form of an image sensor or similar data capture device. Examples of the camera may include the front-facing sensor 130, and the rear-facing sensor 132 of the material handling vehicle 100 of FIG. 1, for example. In further embodiments, the camera can be provided in the form of an attachment to a charging station or facility. In some forms, the camera and/or other aspects of the perception system may be included in the processor 118 of FIG. 1, on a terminal device, a display device, on a mobile device, or a combination thereof. It will be understood that the examples provided are non-limiting.

At step 404, the perception system may be configured to perform image processing (or other data processing) on the input data received from the camera or data store. In an example but not limited to, an image of the material handling vehicle 100 may be processed and one or more elements of the image identified by the perception system. The perception system can extract the image data from the image, recognize one or more items or objects in the image, and determine criteria associated with areas or zones (e.g., charging area, loading area, and maintenance area). In some embodiments, the system can process information related to the location the image was taken (e.g., from metadata, GPS, geotag, geofence information, etc.) to identify the task being performed (e.g., charging zone, loading zone, and maintenance/repair zone, etc.). The computer vision and/or image processing techniques used at step 404 can include boundary boxes, template matching, image segmentation, blob analysis, masking, Gaussian blur, filtering, image enhancement, rotation, scale, color correction, crop, deep learning analysis, other forms of image analysis and processing, or any combination thereof.

In the non-limiting example, the system processes the image(s) and identifies the charging cable is properly connected to the material handling vehicle 100. The system determines the charging status of the material handling vehicle 100. For example, the system validates charging status from the telematics onboard the material handling vehicle 100. Another example or in combination of previous example, the system is integrated with the charger for analysis of the material handling vehicle 100 and/or charging station. The system can also be configured to detect a target object (e.g., charging cable), detect a target condition (e.g., no damage), and a target location (e.g., in port/outlet of material handling vehicle 100). As another example, the system can be configured to detect likely conditions related to a target object based on comparing one or more image frames over a period of time. For example, if a first image of a parking space indicates there are no liquid spots or stains on a driving surface before the material handling vehicle 100 is parked in the spot, and then the system detects a liquid spot or stain on the driving surface after the material handling vehicle 100 leaves the parking spot, then the system may identify this as a likely leak condition and generate a notification for repair and/or maintenance. In some embodiments, the system can also be configured to detect impact detection of charger stations, wear and tear of charging cables, and lead-acid batteries security (e.g., detecting a gate to the battery wash area is secure). In further embodiments, the system can also be configured to detect leaks, and detect an operator presence (e.g., operator inside or outside charging zone), vehicle charging status (e.g., is the charging cable properly connected to the material handling vehicle 100, etc.). In some embodiments, the system uses a trained learning model to determine the designated target objects for one or more target conditions related to the image processing and analysis. In some forms, the designed target objects for one or more target conditions can be provided via user input, a data store input, or similar.

At step 406, the perception system can be configured to categorize one or more elements associated with one or more zones of the processed inputs. For instance, each target object (e.g., charging cable) may be categorized as “Correct” or “Not Correct.” For example, a chart includes of all the recognized target objects, target conditions, and target locations identified in the image by the vision-based system associated with one or more zones. The system may detect identify, and categorize each of the target objects, target conditions, and target locations as “Correct” in the processed image(s). In some embodiments, the system may allow additional items to be added for monitoring. In one instance, the chart may include pre-populated categorizations associated with one or more zones. For example, the chart may include target objects, target conditions, and target locations for a charging area, loading area, and/or maintenance area. For example, in the maintenance area the perception system identifies the target object (e.g., battery stopper), the target condition (e.g., not damaged), and the target location (e.g., battery stopper in place for battery extraction). The system may also identify and categorize target objects, target conditions, and target locations for multiple zones. The system may also determine and/or classify whether an operator is using target objects properly.

the system can generate a notification to be transmitted. In some embodiments, the perception system can generate and/or transmit the notification. In some forms, the notification may be generated and/or transmitted using a notification module (not shown) of the processor 118, other communication module(s) of the material handling vehicle 100, or a remote processing device (e.g., telematics system, cloud server, etc.). The notification may be transmitted to the operator (via the onboard display device 122, a user mobile/computing device, or similar), broadcast to a room where the camera and/or perception system is located, transmitted to one or more users subscribed to the notification type, to a centralized location, to a cloud server, to a monitoring station, to generate a report, or similar. The notification may be provided in the form of an audible alarm, a text message, a telemetry communication from the vision-based system to a centralized database, a warning light, a display message, a vibration, a voice announcement, or a combination thereof. In one instance, the notification can include an image (e.g., an image of an operator who has been identified by the perception system as not using one or more pieces of designated PPE and/or a description of the designated PPE absent and/or present). In some embodiments, the system may automatically generate one or more annotated images including the image captured of the non-compliant operator compared to a compliant PPE configuration for the identified target action. The image and/or notification may be used, for instance, to identify the operator associated with an image, monitor PPE compliance violations, and generate a report or other output including a list of operators who may benefit from additional PPE training based on the identified and/or monitored behaviors.

At step 408, the system can generate a notification to be transmitted. In some embodiments, the perception system can generate and/or transmit the notification. In some forms, the notification may be generated and/or transmitted using a notification module or the processor 118 or other communication module(s) (e.g., near field communication) of the material handling vehicle 100. The notification may be transmitted to the operator (via the onboard display device 122, a user mobile/computing device, or similar), broadcast to a room where the camera and/or perception system is located, transmitted to one or more users subscribed to the notification type, to a centralized location, to a cloud server, to a monitoring station, to generate a report, or similar. The notification may be provided in the form of an audible alarm, a text message, a telemetry communication from the vision-based system to a centralized database, a warning light, a proximity light, a display message, a vibration, a voice announcement, or a combination thereof. In one instance, the notification can prevent the operator from driving off with the charging cable still connected to the material handling vehicle 100. In another non-limiting example, the notification can include an image (e.g., image of an operator who has left the charging zone and forgot to plug the charging cable into the material handling vehicle 100).

In accordance with an example of the present disclosure, a material handling vehicle may include one or more cameras of a perception system designed to execute one or more artificial intelligence algorithms. In one instance, the material handling vehicle may use computer vision to identify key areas of wear or damage on the material handling vehicle. The system can also be used to assess a severity of the wear of the component and classify an overall condition of the component. For instance, the perception system can be used to identify and assess a tire condition, an overhead guard condition, counterweight scratches or other defects, operator seat wear, or a combination thereof. It is to be understood that the list of components and conditions provided is not to be considered limiting. The component(s) and condition(s) may be provided in the form of other components and/or conditions related to material handling vehicles and the environments the material handling vehicles operate in.

In one instance, the machine learning algorithm may categorize the image. For example, a component may be classified as being in a “worn” or “poor” condition or in a “good” condition. However, other assessment levels and categories are possible. For example, there may be multiple levels of wear or damage that can be identified by the vision-based system. In one example embodiment, metadata and/or images, which may be used by or derived from the machine learning algorithms, can be transmitted to a centralized location for generating notifications (e.g., reporting).

In other embodiments, other configurations are possible. For example, those of skill in the art will recognize, according to the principles and concepts disclosed herein, that various combinations, sub-combinations, and substitutions of the components discussed above can provide appropriate control for a variety of different configurations of material handling vehicles, work machines, operator control systems, and so on, for a variety of applications.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A vison-based system for assessing a condition of a component of a material handling vehicle, comprising:
a perception system including one or more cameras, a memory unit, and a processor;
the perception system configured to:
receive input data from the one or more cameras;
process the input data using a machine learning system to identify a condition of the component of the material handling vehicle;
categorize the condition based on an output of the machine learning system; and
generate a notification of the condition of the component.

2. The vison-based system of claim 1, wherein the condition is categorized as “Good” or “Poor”.

3. The vison-based system of claim 1, wherein the identified condition is classified according to a scale relating to a severity of the condition based on one or more parameters evaluated from the input data.

4. The vison-based system of claim 1, wherein the component is a seat of the material handling vehicle, a tire of the material handling vehicle, an overhead guard (OHG) of the material handling vehicle, a counterweight (CW) of the material handling vehicle, or a combination thereof.

5. A vison-based system for monitoring use of personal protective equipment (PPE) by operators handling acids or batteries associated with a material handling vehicle, comprising:
a perception system including one or more cameras, wherein the perception system is configured to:
receive input data from the one or more cameras;
process the input data using a machine learning system to identify one or more objects in the input data;
determine whether a target PPE item is present in the input data using an image processing technique;
categorize the target PPE item as being present or absent based on an output of the machine learning system; and
generate a notification including an indication of whether the target PPE item is present or absent.

6. The vison-based system of claim 5, wherein the target PPE is provided in the form of a face shield, an apron, gloves, or a combination thereof.

7. The vision-based system of claim 5, wherein the machine learning system is further configured to identify a target object.

8. The vision-based system of claim 7, wherein the target object is provided in the form of a battery.

9. The vision-based system of claim 5, wherein the machine learning system is further configured to identify a target action.

10. The vision-based system of claim 9, wherein the target action is provided in the form of watering a battery.

11. The vision-based system of claim 10, wherein the machine learning system is further configured to:
detect the target action in the input data;
recognize the target action using one or more image processing techniques;
determine the target PPE associated with the target action;
identify the presence or absence of each aspect of the target PPE based on the one or more image processing techniques; and
generate a notification including the target action, any target objects, the target PPE associated with the target action, and an output including a description or other indication of the aspects of the target PPE that are present and/or absent based on the output of the machine learning system.

12. A method for operating a vision-based method using a perception system for monitoring proper use of PPE by operators handling acids or batteries, the method comprising:
receiving input data from one or more cameras of the perception system;
automatically processing the input data using a machine learning system to identify whether a target PPE item is present;
categorizing the target PPE item as being present or absent based on an output of the machine learning system; and
generating a notification based on whether the target PPE item is present or absent from the input data.

13. The method of claim 12, wherein the target PPE is provided in the form of a face shield, an apron, gloves, or a combination thereof.

14. The method of claim 12, further comprising:
determine whether a target object is present in the input data;
categorize the target object as being correct or not correct based on an output; and
generate an updated notification including an indication of whether the target object is correct or not correct.

15. The method of claim 12, wherein the input data from one or more cameras comprises image data.

16. The method of claim 14, wherein the one or more target objects are associated with one or more zones.

17. The method claim 14, wherein the machine learning system further identifies:
one or more target conditions; and
one or more target locations.

18. The method of claim 17, wherein the one or more target conditions and the one or more target locations are associated with the one or more zones.

19. The method of claim 17, wherein the one or more target conditions and the one or more target locations are associated with charging the material handling vehicle.

20. The method of claim 14, wherein the notification includes one or more images captured by the one or more cameras.
